(19) United States
(12) Patent Application Publication
(10) Pub. No.: US 2025/0140881 A1
(43) Pub. Date: May 1, 2025

(54) FUEL CELL SYSTEM, AND TANK SYSTEM FOR A FUEL CELL SYSTEM

(71) Applicant: Robert Bosch GmbH, Stuttgart (DE)

(72) Inventors: Jochen Wessner, Esslingen (DE); Martin Katz, Stuttgart (DE)

(21) Appl. No.: 18/834,386

(22) PCT Filed: Jan. 10, 2023
(86) PCT No.: PCT/EP2023/050381

§ 371 Date: Jul. 30, 2024

(30) Foreign Application Priority Data
Feb. 22, 2022 (DE) 10 2022 201 827.3

(51) Int. Cl. H01M 8/04007; H01M 8/04082; H01M 8/0432; H01M 8/0438; H01M 8/04701; H01M 8/04746

(52) U.S. Cl. CPC H01M 8/04074; H01M 8/04216; H01M 8/0432; H01M 8/0438; H01M 8/04708; H01M 8/04753

(57) ABSTRACT

A tank system for a fuel cell system comprises a tank which extends along a longitudinal axis for receiving gas, in particular hydrogen, comprising an outer circumferential surface which encloses the longitudinal axis along a circumferential direction; a strip-shaped cooling device which is thermally coupled to the tank and comprises at least one Peltier element, wherein the cooling device is arranged on the outer circumferential surface of the tank and extends along the circumferential direction of the tank; and a securing element which encloses the outer circumferential surface of the tank in the circumferential direction and presses the cooling device against the outer circumferential surface of the tank.

### BACKGROUND

The present invention relates to a fuel cell system and a tank system for a fuel cell system.

Fuel cell systems conventionally comprise a fuel cell arrangement in the form of, e.g., a stack having a large number of fuel cells connected electrically in series. The fuel cell arrangement is supplied with gaseous fuel, e.g. hydrogen, from a tank via a fuel supply line. In both stationary and mobile applications, such as in a vehicle, the gaseous fuel in the tank is typically at high-pressure, which can, e.g., be up to 700 bar or more.

In vehicles, e.g. in cars or trucks, gaseous fuels such as hydrogen can be used with high efficiency in fuel cells. For this purpose, vehicles carry appropriate tank systems with tank containers in which the fuel is stored. In order to prevent uncontrolled gas leakage in the event of thermal or mechanical effects on the tank containers, the tank containers are usually fitted with a safety valve via which the gas is released from the tank container into the surroundings when a limit pressure and/or a limit temperature is reached. Such a tank system for a vehicle is described, for example, in DE 10 2014 101 139 A1.

U.S. Pat. No. 8,408,254 A also discloses a hydrogen tank that is cooled by a Peltier element during filling.

### SUMMARY

Provided according to the disclosure is a tank system and a fuel cell system.

According to a first aspect of the invention, a tank system for a fuel cell system comprises a tank extending along a longitudinal axis for receiving gas, in particular hydrogen, with an outer circumferential surface enclosing the longitudinal axis along a circumferential direction and a strip-shaped cooling device thermally coupled to the tank and having at least one Peltier element, wherein the cooling device is arranged on the outer circumferential surface of the tank and extending along the circumferential direction. Furthermore, the tank system has a securing element which encloses the outer circumferential surface of the tank in the circumferential direction and presses the cooling device against the outer circumferential surface of the tank.

According to a second aspect of the invention, a fuel cell system comprises a fuel cell arrangement with at least one fuel cell, a fuel inlet for supplying gaseous fuel, an oxidizing gas inlet for supplying oxidizing gas and a product outlet for discharging reaction products, a fuel supply line connected to the fuel inlet and a tank system according to the first aspect of the invention, wherein the tank is connected to the fuel supply line in a fluidically conductive manner.

An idea underlying the invention is to cool the tank by means of a Peltier cooling device extending along the circumferential direction, for example when a temperature and/or in the pressure reach a predetermined limit value, and to mechanically secure the cooling device to the outer circumferential surface by means of a securing or fixing element which also extends along a circumferential direction of the tank. The securing element completely encloses the outer circumferential surface so that the cooling device is clamped between the outer circumferential surface and the securing element. It may be provided that a securing element fixes multiple cooling devices at a distance along the longitudinal axis. Alternatively, each cooling device can be fixed by its own securing element.

The cooling device has at least one Peltier element. The Peltier element comprises a large number of p- and n-doped semiconductor elements, which are alternately contacted with each other at opposite ends by electrical conductor bridges. The Peltier element has a first side defined by a first surface, which forms a heat sink or “cold side”, and a second side defined by an oppositely located second surface, which forms a heat source or “warm side”. The cooling device is arranged on the outer circumferential surface of the tank such that the cold side of the Peltier element is oriented towards the outer circumferential surface. The cooling device encloses the outer circumferential surface of the tank in the circumferential direction at least partially, optionally completely.

One advantage of the invention is that the mechanical fixing of the strip-shaped cooling device by means of the securing elements can be installed quickly and easily. Furthermore, the contact pressure exerted on the cooling device by the securing elements improves the heat transfer between the tank and the cooling device. Another advantage is that the securing elements are in contact with the cooling device. This increases the surface area on which heat is exchanged with the surroundings, which further improves the cooling effect of the cooling device.

Advantageous embodiments and developments emerge from the further dependent claims and from the description with reference to the figures of the drawing.

According to some embodiments, it can be provided that the cooling device comprises an elongate, strip-shaped Peltier element. Alternatively, it can be provided that the cooling device has a large number of Peltier elements, e.g., in the form of disks or plates, which are arranged next to each other or in succession and connected to each other by a strip-shaped holder.

According to some embodiments, it can be provided that the tank comprises at least two struts located at a distance along a longitudinal axis and protruding from the outer circumferential surface, in particular along a radial direction extending transversely to the longitudinal axis, wherein the cooling device is arranged between two adjacent struts with respect to the longitudinal axis. In the most general case, the struts are therefore projections that protrude from the outer circumferential surface of the tank. The struts are arranged at a distance in the longitudinal direction. Optionally, multiple struts can be provided at one point in relation to the longitudinal axis, which are arranged at a distance in the circumferential direction. For example, it can be provided that at least two struts arranged at a distance along the circumferential direction are arranged in a first axial end region of the tank and at least two struts are arranged at a distance along the circumferential direction are arranged in a second axial end region of the tank, which is located opposite to the first end region with respect to the longitudinal axis. The struts therefore offer a simple mounting option that can be used to connect the tank to a support or upright structure.

According to some embodiments, it can be provided that the cooling device rests against a thermally conductive protective layer with an outer surface facing away from the outer circumferential surface of the tank. Accordingly, a second surface, the “warm” surface of the cooling device, can be covered by a protective layer, e.g., a metal foil. The protective layer is therefore located between the securing element and the cooling device. The protective layer protects the cooling device from mechanical influences. It is also a simple way of increasing the surface area available for heat dissipation to the surroundings, e.g., by making the film larger than the cooling device itself.

According to some embodiments, it can be provided that a plurality of cooling devices are arranged on the outer circumferential surface of the tank at a distance from each other with respect to the longitudinal axis, wherein a greater cooling capacity defined by the cooling devices is installed in a first axial region than in a second axial region. In this way, heat dissipation can be advantageously increased in a predetermined axial region, e.g., in a region where a filler neck projecting into the tank ends. According to some embodiments, the installed cooling capacity in the first axial region can be increased by the fact that a larger surface area of the outer circumferential surface is occupied by the cooling devices in the first axial region than in the second axial region. For example, a larger number of cooling devices per length along the longitudinal axis can be installed in the first axial region than in the second axial region. Alternatively or additionally, a cooling device can be installed in the first axial region, which has a greater width along the longitudinal axis than a respective cooling device in the second axial region.

According to some embodiments, it can be provided that the securing element is designed as a mesh. In particular, the mesh is designed as a ring that encloses the outer circumferential surface, wherein the respective cooling device is located between the mesh and the outer circumferential surface. The advantage of the mesh design is that only a small region of the surface of the cooling device facing away from the outer circumferential surface of the tank is covered, so that the convective heat transfer between the cooling device and the surroundings is further improved.

According to some embodiments, it can be provided that the mesh is made of an elastically deformable material, for example an elastomeric material, and is elastically deformed such that it exerts a biasing force on the cooling device perpendicular to the longitudinal axis in order to press the cooling device against the outer circumferential surface of the tank.

According to some embodiments, it can be provided that the securing element is designed as a shrink tubing, which is shrunk onto the outer circumferential surface of the tank. The shrink tubing can be, for example, a sleeve-shaped part made of a thermoplastic or elastomeric material, which encloses the outer circumferential surface, wherein the respective cooling device is located between the shrink tubing and the outer circumferential surface. The shrink tubing can be made of polyolefin, polyvinyl chloride, polytetrafluoroethylene or an ethylene-propylene-diene rubber, for example. The shrink tubing can therefore be realized as a cold or hot shrink tubing. One advantage of using a shrink tubing as a securing element is that it is easy to install. A further advantage lies in the uniform contact pressure exerted by the stocking hose on the cooling device over the entire surface and along the circumference.

According to some embodiments, it can be provided that the shrink tubing has a large number of openings which expose the cooling device in some regions and which are arranged at a distance from one another along the circumferential direction. The openings are therefore through-openings, which further improve the convective heat exchange between the “warm” side of the cooling device and the surroundings.

According to some embodiments, it can be provided that the tank system has a safety valve which is connected to the tank in a fluid-conducting manner and which can be switched from a closed position to a release position in order to release gas from the tank, a sensor arrangement for detecting a pressure and/or a temperature in the tank as state variables, and a control device which is connected in a signal-conducting manner to the safety valve, the cooling device and the sensor arrangement and is set up for this purpose: energizing the at least one Peltier element of the cooling device in order to cool the tank when at least one state variable detected by the sensor arrangement exceeds a first limit value, and switching the safety valve to the release position when the at least one state variable detected by the sensor arrangement exceeds a second limit value which is greater than the first limit value.

As a result, if a first temperature limit value and/or a first pressure limit value is moderately exceeded, then the tank can be cooled by means of the cooling device in order to return the thermodynamic state of the gas in the tank to a target range in order to, i.e., reduce the pressure and/or temperature without releasing gas from the tank into the surroundings. The safety valve is only opened when a higher, second limit value for the temperature and/or pressure in the tank is exceeded. The thermodynamic state of the gas in the tank can be approximated by the ideal gas equation. It can therefore be sufficient to detect only the pressure or the temperature using sensors, wherein the detection of both variables as state variables is advantageous. The measured state variables are evaluated by means of the control device, which can, e.g., comprise a processor unit, e.g., a CPU or the like, and a data storage means, in particular a non-volatile data memory such as a hard disk, a flash memory, an SD memory, or the like. The data storage means can be read out by the processor unit and can, e.g., store software executable by the processor, which causes the control device to output electrical and/or electromagnetic signals in order to actuate the cooling device and the safety valve. One advantage of this embodiment is that gas is only released into the surroundings via the safety valve if this is absolutely necessary, as minor deviations from the target state can be efficiently intercepted by the cooling device.

### BRIEF DESCRIPTION OF THE DRAWINGS

The invention is explained below with reference to the figures of the drawings. The drawings show:

FIG. 1 a schematic representation of a fuel cell system according to an exemplary embodiment of the invention;

FIG. 2 a schematic sectional view of a tank of a tank system according to an exemplary embodiment of the invention, wherein the sectional view results in a section parallel to a longitudinal axis of the tank;

FIG. 3 a plan view of an outer circumferential surface of a tank of a tank system according to an exemplary embodiment of the invention;

FIG. 4 a plan view of an outer circumferential surface of a tank of a tank system according to a further exemplary embodiment of the invention;

FIG. 5 a sectional view of the tank shown in FIG. 3 or 4 in a section transverse to the longitudinal axis of the tank;

FIG. 6 a plan view of an outer circumferential surface of a tank of a tank system according to a further exemplary embodiment of the invention; and

FIG. 7 a flow diagram of a method for monitoring a tank system.

### DETAILED DESCRIPTION

In the drawings, identical reference signs denote identical or functionally identical components, unless stated otherwise.

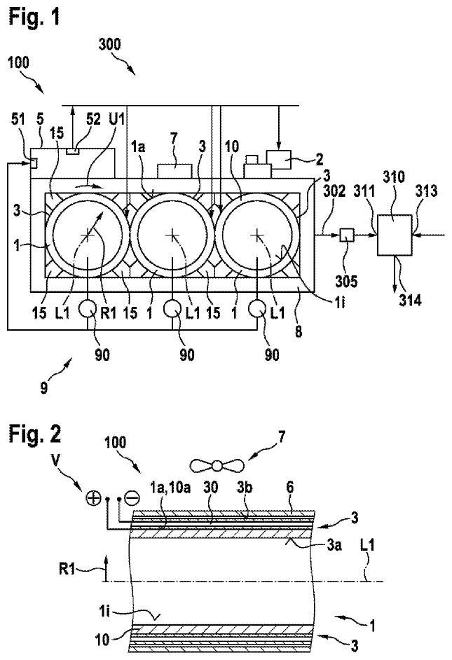

FIG. 1 schematically shows a fuel cell system 300 as it can be used, for example, in a mobile application such as a vehicle, in particular a road vehicle. As shown in FIG. 1, the fuel cell system 300 has a tank system 100, a fuel cell arrangement 310 and a fuel supply line 302.

The fuel cell arrangement 310 is only shown symbolically in FIG. 1 and comprises at least one fuel cell. Optionally, the fuel cell arrangement 310 can comprise a large number of fuel cells electrically connected in series, which can, e.g., be arranged in what is referred to as a stack. Each fuel cell comprises an anode, a cathode and an electrolyte arranged between the anode and cathode. As shown schematically in FIG. 1, the fuel cell arrangement 310 comprises a fuel inlet 311, an oxidizing gas inlet 313, and a product outlet 314. The fuel supply line 302 is connected to the fuel inlet 311 and the tank system 100, so that gaseous fuel, such as hydrogen, can be supplied from the tank system 100 to the fuel inlet 311 through the fuel supply line 302. Oxidizing gas, such as ambient air, can be supplied to the fuel cell arrangement 310 via the oxidizing gas inlet 313. The oxidizing gas is fed to the cathode and the fuel is fed to the anode of the at least one fuel cell, wherein an oxidation reaction takes place at the anode and a reduction reaction takes place at the cathode. The reaction products are discharged via the product outlet 314.

As further shown schematically in FIG. 1, a flow control valve 305 can optionally be arranged in the fuel supply line 302 in order to be able to vary the mass flow of fuel into the fuel cell arrangement 310 more easily.

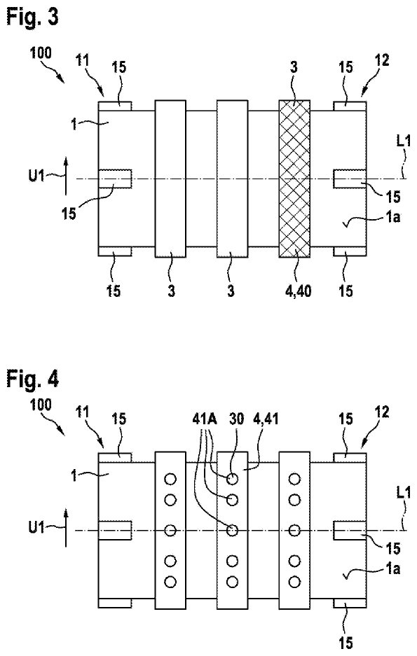

As shown schematically and purely by way of example in FIG. 1, the tank system 100 has a tank 1, an optional safety valve 2, a cooling device 3, an optional sensor arrangement 9, and an optional control device 5. Optionally, a fan or blower 7 can also be provided, which is only shown symbolically as a block in FIG. 1. The tank system 100 further comprises at least one securing element 4 (as shown schematically and by way of example in FIGS. 3 to 5).

FIG. 1 shows a purely exemplary tank system 100, which comprises multiple (in this example three) individual tanks 1. Of course, it is also possible for the tank system 100 to comprise only a single tank 1 or a number other than three tanks 1. For reasons of clarity, the term “one tank” will therefore be used hereinafter. However, the explanations always apply to all tanks of the system 100, unless otherwise specified. The tank 1 is designed to receive gas, in particular hydrogen. For example, the tank 1 can comprise an outer wall 10 with an inner circumferential surface 1i that defines an inner volume for receiving the gas. For example, the tank 1 can be cylindrical in shape, as shown schematically in the sectional view in FIG. 1. In general, the tank 1 extends along a longitudinal axis L1. An outer circumferential surface 1a of the tank 1 located opposite the inner circumferential surface 1i encloses the longitudinal axis L1 in a circumferential direction U1 and can, for example, be designed as a cylindrical surface. In the case of a cylindrical tank 1, the longitudinal axis L1 corresponds to the cylinder axis. If multiple tanks 1 are provided (as shown by way of example in FIG. 1), these can, e.g., be arranged next to each other such that their longitudinal axes L1 extend parallel to each other. Optionally, the tank 1 can be accommodated in a tank housing 8. As shown in FIG. 1 by way of example, in the case of multiple tanks 1, all of the tanks 1 can be accommodated in the same tank housing 8.

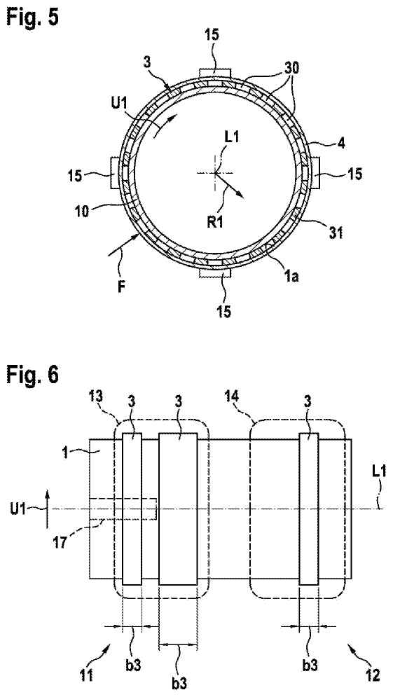

Furthermore, the tank 1 can optionally comprise at least two struts 15 that protrude from the outer circumferential surface 1a. As shown in FIGS. 3 and 4, a plurality of struts 15 arranged at a distance along the circumferential direction U1 of the tank 1 can be provided in opposite first and second axial end regions 11, 12 of the tank 1. In general, however, only at least two struts 15 can be provided, which are arranged at a distance along the longitudinal axis L1. As in particular seen in in FIG. 1, the struts 15 can, e.g., protrude from the outer circumferential surface 1a of the tank 1 in a radial direction R1 extending perpendicular to the longitudinal axis L1. As shown in FIGS. 1 and 5, four struts 15 can, e.g., be provided in each end region 11, 12, which are arranged at equal angular distances from one another along the outer circumferential surface 1a of the tank 1. As seen in FIG. 3, the struts 15 can be designed as essentially block-shaped elements or supports. In general, the struts 15 are fixedly connected to the tank 1 or the outer wall 10 of the tank 1, e.g., welded, glued, or the like thereto. As shown in FIG. 1 by way of example, the struts 15 can extend between the outer wall 10 of the tank 1 and the tank housing 8, so that the tank 1 is connected to the tank housing 8 via the struts 15.

The tank 1, in particular its internal volume, is fluidically connected to the fuel supply line 302. As a result, gas from the tank 1 can be fed into the fuel cell arrangement 310.

As seen in FIGS. 3 and 4, the cooling device 3 is designed as a strip-shaped component. The cooling device 3 comprises at least one Peltier element 30. The Peltier element 30 features a conventional structure in which a large number of p- and n-doped semiconductor elements are alternately contacted by each other at opposite ends by electrical conductor bridges. FIG. 2 schematically shows a broken, enlarged sectional view of a tank 1 from FIG. 1, which results from a section along the longitudinal axis L1. The Peltier element 30 comprises a first side defined by a first surface, which forms a heat sink or “cold side”, and a second side defined by an oppositely located second surface which forms a heat source or “warm side”. The cooling device 3 and in particular the Peltier element 30 is thermally coupled to the tank 1. As shown in particular in FIGS. 2 and 5, the cooling device 3 is arranged for this purpose in thermally conductive contact with the outer circumferential surface 1a of the tank 1. As shown schematically in FIG. 2, the cooling device 3 can be oriented such that a first surface 3a of the cooling device 3 is in contact with the outer circumferential surface 1a of the tank 1. The first surface 3a of the cooling device 3 corresponds to the “cold side” of the Peltier element 30 or the “cold side” of the Peltier element 30 is oriented towards the outer circumferential surface 1a. When the Peltier element 3 of the cooling device 3 is connected to an electrical voltage source V, so that a current flows through the Peltier element 3, the temperature of the “cold side” or the first surface 3a of the cooling device 3 decreases. Consequently, the Peltier element 30 absorbs heat from the tank 1 and releases it to the surroundings on a second surface 3b of the cooling device 3, which is located away from the outer circumferential surface 1a of the tank 1. As further shown in FIG. 2, it can optionally be provided that the cooling device 3 rests with the second surface 3b against a thermally conductive protective layer 6, e.g., a metal foil or the like covering the cooling device 3.

The cooling device 3 can, e.g., comprise an elongated, strip-shaped Peltier element 3 that extends along the circumferential direction U1. Alternatively, it can be provided that the cooling device has a large number of, for example, disk- or plate-shaped Peltier elements 30, which are arranged next to each other or in succession and are connected to each other by a strip-shaped holder 31, as shown schematically and purely by way of example in FIG. 5.

As shown schematically in FIGS. 3 to 5, the cooling device 3 extends along the circumferential direction U1 of the tank 1. For example, the cooling device 3 can completely enclose the outer circumferential surface 1a of the tank 1, as shown by way of example in FIG. 5. As can be seen in FIGS. 3 and 4, multiple cooling devices 3 can be arranged at a distance from one another along the longitudinal axis LI on the outer circumferential surface 1a of the tank 1. In general, at least one cooling device 3 is provided. As shown in FIGS. 3 and 4, the cooling device 3 or the cooling devices 3 can be arranged between two adjacent struts 15 along the longitudinal axis L1.

FIG. 6 shows a purely exemplary tank system 100, which has a plurality of cooling devices 3, arranged at a distance from one another on the outer circumferential surface 1a of the tank 1 in relation to the longitudinal axis L1. As shown in FIG. 6 by way of example, two cooling devices 3 can be provided in a first axial region 13, while only one cooling device 3 is provided in a second axial region 12, which is located at a distance from the first axial region 13 with respect to the longitudinal axis L1. FIG. 6 also shows that one of the cooling devices 3 provided in the first axial region 13 has a greater width b1 along the longitudinal axis L1 than the other cooling devices 3. Thus, based on the length of the first axial region 13 and the length of the second axial region 14 along the longitudinal axis L1, a larger area of the outer circumferential surface 1a of the tank 1 is occupied by cooling devices 3 in the first axial region 13 than in the second axial region 14. Consequently, a greater cooling capacity defined by the cooling devices 3 is installed in the first axial region 13 than in a second axial region 14. Instead of a cooling device 3 with a larger width b3, a larger number of cooling devices 3 can also be provided in the first region 13. Conversely, the same or a smaller number of cooling devices 3, but with a greater width b3, can also be provided in the first region 13.

As shown in FIG. 6 by way of example, the first axial region 13 can be directly adjacent to the first end region 11 or coincide with it. As further shown in FIG. 6, one end of a filler neck 17, via which gas can be supplied to the tank 1, can be located in the first axial region 13. In general, it is advantageous if the first axial region 13 overlaps with regions or structures of the tank 1 that are subject to high thermal stress.

The securing element 4 is used to fix the strip-shaped cooling device 3 to the outer circumferential surface 1a of the tank 1. In general, each cooling device 3 can be provided with its own securing element 4, or one securing element 4 can fix multiple cooling devices 3. For the sake of simplicity, the term “the securing elements” will be used hereinafter. However, the explanations also apply, without limiting the invention, in the event that only one securing element is provided. As shown in FIGS. 3 to 5, the securing elements 4 extend generally along the circumferential direction U1 and are arranged and designed such that they press the cooling device 3 against the outer circumferential surface 1a of the tank 1. For this purpose, the securing elements completely enclose the outer circumferential surface 1a of the tank 1, and the respective cooling device 3 is clamped or fixed between the securing element 4 and the outer circumferential surface 1a. The securing element 3 exerts a contact pressure or biasing force F on the cooling device 3, which is directed along the radial direction R1, so that the cooling device 3 is pressed against the outer circumferential surface 1a of the tank 1.

As shown in FIG. 3, purely by way of example and only schematically, the securing element 4 can be designed as a mesh 40. In FIG. 3, the mesh 40 is only shown on one of the cooling devices 3 for reasons of clarity. In particular, the mesh 40 can be made of an elastically deformable material, e.g., an elastomer material. For example, the mesh 3 can be designed as a mesh hose or generally as a belt-shaped element which, in an undeformed state of the mesh 3, defines an inner diameter that is smaller than an outer diameter of the tank 1 with the cooling device 3 arranged thereon. In the state installed on the tank 1, the mesh 3 is elastically deformed such that it exerts a biasing force F on the cooling device 3 perpendicular to the longitudinal axis L1 in order to press the cooling device 3 against the outer circumferential surface 1a of the tank 1.

As shown in FIG. 4, purely by way of example and only schematically, a shrink tubing 41 can also be provided as a belt-shaped securing element 4. FIG. 4 shows by way of example that a separate shrink tubing 41 is provided for each cooling device 3. However, it would also be conceivable to fix all cooling devices 3 with just one shrink tubing 41. The shrink tubing 41 is shrunk onto the outer circumferential surface 1a of the tank 1, so that the cooling device 3 is located between the shrink tubing 41 and the outer circumferential surface 1a and the shrink tubing 41 exerts the contact pressure or biasing force F on the cooling device 3. The shrink tubing 41 can be designed as a tubular part that contracts when heated. For example, the shrink tubing 41 can be made of polyolefin, polyvinyl chloride, polytetrafluoroethylene, or a thermoplastic material. Alternatively, the shrink tubing 41 can be formed as a cold shrink tubing from an ethylene-propylene-diene rubber or another elastomer.

As further shown in FIG. 5, the shrink tubing 41 can optionally comprise a large number of openings 41A, which expose the cooling device 3 in some regions and which are arranged at a distance from one another along the circumferential direction U1.

The optional blower 7 is shown schematically in FIG. 2. For example, the fan 7 can be arranged relative to the tank 1 such that it can transport a fluid flow for heat dissipation over the warm side or the second surface 3b of the cooling device 3. For example, the fan 7 can be arranged opposite the cooling device 3. As shown symbolically in FIG. 1, the blower 7 can also be accommodated in an exhaust air recess in the tank housing 8, so that it draws ambient air into the tank housing 8 through a supply air opening (not shown) and expels the air out of the tank housing 8 again via the exhaust air opening.

The optional safety valve 2 can be designed as a switchable valve, e.g., as a solenoid valve. In general, the safety valve 2 can be switched between a closed position and a release position or open position. In the closed position, the safety valve 2 blocks a flow cross-section so that the flow of gas through the flow cross-section is prevented. In the open position, the safety valve enables gas to flow through the flow cross-section. In FIG. 1, the safety valve 2 is only shown symbolically on the outside of the optional tank housing 8. In general, the safety valve 2 is fluidically connected to the tank 1 so that gas can be released from the tank 1, in particular into the surroundings, when the safety valve 2 is switched from its closed position to its release position. In principle, a separate safety valve 2 can be provided for each tank 1 in order to be able to release gas from each tank 1 individually. Alternatively, multiple tanks 1 can be fluidically connected to one another, so that a common safety valve 2 can be provided for the interconnected tanks 1.

The sensor arrangement 9 is designed to detect a pressure and/or a temperature in the tank 1 as state variables. As shown only symbolically in FIG. 1, the sensor arrangement 9 can comprise one or multiple sensors 90. For example, at least one pressure sensor, which detects the pressure in the respective tank 1, and/or one temperature sensor, which detects the temperature in the respective tank 1, can be provided for each tank 1. The sensors 90 can, for example, be designed as simple pressure or temperature monitors that only emit a corresponding signal when predetermined limit values are exceeded. Alternatively, it is conceivable that the sensors 90 are designed as measuring devices that continuously output measurement signals representing the respective measured variable. As a result, the state variables in the tank are able to to be detected continuously.

The control device 5 is shown symbolically as a block in FIG. 1 and can, for example, be designed as an electronic control device 5. In particular, the control device 5 can comprise an input interface 51, an output interface 52, a processor unit (not shown), and a data storage means (not shown). The data storage means can be read by the processor unit and can, e.g., store software that can be executed by the processor unit. The software can cause the processor to generate output or control signals based on input signals received at the input interface 51 and output them at the output interface 52. The input and output interfaces 51, 52 can, e.g., be implemented as wired interfaces, e.g. bus interfaces such as CAN bus interfaces, or as wireless interfaces such as WiFi, Bluetooth, or the like. In general, the interfaces 51, 52 are configured for the exchange of electrical or electromagnetic signals. The processor unit can comprise one or multiple processors, e.g. a CPU, a microcontroller, an ASIC, an FPGA, or the like. In particular, the data storage means can be a non-volatile data storage means, such as a hard disk, a CD or DVD-ROM, a flash memory, an SD memory, or the like.

The control device 5 is connected to the safety valve 2, the cooling device 3, and the sensor arrangement 9 in a signal-conducting manner. As shown schematically in FIG. 1, the input interface 51 can be connected to the sensor arrangement 9, in particular the sensors 90, and the output interface 52 can be connected to the safety valve 2 and the cooling device 3. The control device 5 is configured to generate control signals based on the measurement or detection signals received from the sensor arrangement 9, which represent at least one state variable (pressure and/or temperature) in the tank 1 in order to control and actuate the at least one Peltier element 30 of the respective cooling device 3 and/or the safety valve 2.

FIG. 7 shows a flowchart of a method M for monitoring a tank system 100, which is performed when a gas such as hydrogen is stored in the tank 1. In particular, the control device 5 can be designed to cause the tank system 100, e.g. a tank system 100 from FIGS. 1 through 6, to perform this method M. The method M shown in FIG. 7 will then be explained by way of example with reference to the tank systems 100 shown in FIGS. 1 to 6.

In step M1, the pressure and/or temperature in the tank 1 are detected as state variables using the sensors 90 of the sensor arrangement 9. As previously addressed hereinabove, this can optionally comprise continuous detection of the state variables, or merely detecting the exceeding of a limit value. The control device 5 receives the signals representing the state variables from the sensor arrangement 9 as input signals at the input interface 51. In general, at least one state variable is detected. For the sake of simplicity, however, reference will be made to a plurality of state variables hereinafter. With regard to the comparison of the state variables with a limit value, this means that each detected state variable is compared with a respective limit value. In the case of decision steps of method M, it can be sufficient for the positive case (“YES” or logical “1”) in the case of multiple detected state variables that one of the state variables exceeds or falls below its respective limit value.

In a further step M11, the control device 5 compares with a first limit value, e.g. a first temperature limit value and/or a first pressure limit value. If the detected state variables exceed the first limit value, as shown in FIG. 7 by the “+” symbol, then the method M proceeds to step M12. If the detected state variables do not exceed the first limit value, as shown in FIG. 7 by the symbol “−”, then the method M goes back to step M1.

In step M12, the control device 5 compares the detected state variables with a second limit value, e.g. with a first temperature limit value and/or a first pressure limit value. The second limit value is greater than the first limit value. In other words, the second temperature limit value and/or the second pressure limit value is at a higher temperature or a higher pressure than the first temperature limit value or the first pressure limit value.

If it is determined in step M12 that the detected state variables exceed the second limit value, as shown in FIG. 7 by the symbol “+”, then the method proceeds to step M4. In step M4, the control device 5 emits a control signal at the output interface 52, which switches the safety valve 2 to its open position so that gas is released from the tank 1.

If it is determined in step M12 that the detected state variables do not exceed the second limit value, as shown in FIG. 7 by the symbol “−”, then the method can proceed directly to step M3 or, as shown by way of example in FIG. 7, to optional step M2.

The prerequisite for step M2 is the continuous detecting of the state variables. In this case, the control device 5 receives time-resolved measured values for the state variables and determines a gradient of the state variables in step M2. A parameter can therefore be determined for the temperature and/or pressure, which represents whether the temperature and/or pressure in tank 1 changes quickly or slowly.

In step M21, the control device 5 compares the determined gradient with a predetermined change limit value. If it is determined in step M21 that the gradient is smaller than the change limit value, then the method proceeds to step M3.

In step M3, the control device 5 outputs a control signal to the at least one Peltier element 30 of the respective cooling device 3 of the respective tank 1, whereby the Peltier element 30 is electrically conductively connected to the voltage source V such that the first surface 3a of the cooling device 3 forms a heat sink in order to cool the tank 1. As previously explained hereinabove, the method M can proceed directly to step M3 if it is determined in step M12 that the detected state variables do not exceed the second limit value. If the optional step M2 is performed, an additional test step is performed, and the tank 1 is cooled by means of the cooling device 3 in step M3 only if it is determined in step M21 that the determined gradient is less than the predetermined change limit value.

If it is determined in step M21 that the determined gradient is greater than or equal to the predetermined change limit value, as shown in FIG. 7 by the symbol “−”, then method M returns to step M4. In other words, if the state variables in the tank change quickly, then gas is drained directly from the tank, especially if it was determined in step M12 that the detected state variables did not exceed the second limit value.

As further shown in FIG. 7, the method M can additionally comprise the optional steps M41 and M5. In step M41, the control device 5 compares the actual values of the state variables detected by the sensor arrangement 9 with a third limit value, which is smaller than the second limit value and preferably even smaller than the first limit value. If it is determined in step M41 that the state variables are below the third limit value, as shown in FIG. 7 by the “+” symbol, then step M5 is performed, during which the draining of gas from tank 1 is stopped. For this purpose, the control device 5 emits a further control signal at the output interface 52 in order to switch the safety valve 2 from its open position to its closed position. If it is determined in step M41 that the state variables are not yet below the third limit value, as shown in FIG. 7 by the symbol “−”, then step M4 is still performed, i.e., gas is still released from tank 1.

Although the present invention has been explained hereinabove by way of example with reference to exemplary embodiments, it is not limited thereto and can be modified in many ways. Combinations of the above exemplary embodiments are in particular also conceivable.

1. A tank system (100) for a fuel cell system (300) comprising:
a tank (1) which extends along a longitudinal axis (L1) for receiving gas and comprising an outer circumferential surface (1a) which surrounds the longitudinal axis (L1) along a circumferential direction (U1);
a strip-shaped cooling device (3) which is thermally coupled to the tank (1) and comprises at least one Peltier element (30), wherein the cooling device (3) is arranged on the outer circumferential surface (1a) of the tank (1) and extends along the circumferential direction (U1) of the tank (1); and
a securing element (4) which encloses the outer circumferential surface (1a) of the tank (1) in the circumferential direction (U1) and presses the cooling device (3) against the outer circumferential surface (1a) of the tank (1).

2. The tank system (100) according to claim 1, wherein the tank (1) comprises at least two struts (15), which are arranged at a distance along the longitudinal axis (L1) and protrude from the outer circumferential surface (1a), wherein the cooling device (3) is arranged between two adjacent struts (15) with respect to the longitudinal axis (L1).

3. The tank system (100) according to claim 2, further comprising:
a tank housing (8) surrounding the tank (1), wherein the at least two struts (15) extend between the outer circumferential surface (1a) of the tank (1) and the tank housing (8).

4. The tank system (100) according to claim 1, wherein a plurality of cooling devices (3) are arranged on the outer circumferential surface (1a) of the tank (1) at a distance from one another with respect to the longitudinal axis (L1), wherein an installed cooling capacity defined by the cooling devices (3) is greater in a first axial region (13) than in a second axial region (14).

5. The tank system (100) according to claim 1, wherein the securing element (4) is configured as a mesh (40).

6. The tank system (100) according to claim 5, wherein the mesh (40) is made of an elastically deformable material and is elastically deformed such that it exerts a biasing force (F) directed perpendicular to the longitudinal axis (L1) on the cooling device (3) in order to press the cooling device (3) against the outer circumferential surface (1a) of the tank (1).

7. The tank system (100) according to claim 1, wherein the securing element (4) is configured as a shrink tubing (41), which is shrunk onto the outer circumferential surface (1a) of the tank (1).

8. The tank system (100) according to claim 7, wherein the shrink tubing (41) comprises openings (41A), regions of which expose the cooling device (3) and which are arranged at a distance from one another along the circumferential direction (U1).

9. The tank system (100) according to claim 1, further comprising:
a safety valve (2), which is fluidically connected to the tank (1) and can be switched from a closed position to a release position in order to release gas from the tank (1);
a sensor arrangement (9) for detecting a pressure and/or a temperature in the tank (1) as state variables;
a control device (5) which is connected to the safety valve (2), the Peltier element (3), and the sensor arrangement (9) in a signal-conducting manner and is configured to:
energize the Peltier element (3) to cool the tank (1) when at least one state variable detected by the sensor arrangement (9) exceeds a first limit value, and
switch the safety valve (2) to the release position if the at least one state variable detected by the sensor arrangement (9) exceeds a second limit value which is greater than the first limit value.

10 A fuel cell system (300) comprising:
a fuel cell arrangement (310) having at least one fuel cell, a fuel inlet (311) for supplying gaseous fuel, an oxidation gas inlet (313) for supplying oxidation gas, and a product outlet (314) for removing reaction products;
a fuel supply line (302) connected to the fuel inlet (311); and
a tank system (100) according to claim 1;
wherein the tank (1) is fluidically connected to the fuel supply line (302).

11. The tank system (100) according to claim 1, wherein the tank (1) receives hydrogen gas.

12. The tank system (100) according to claim 4, wherein the installed cooling capacity defined by the cooling devices (3) is greater in the first axial region (13) than in the second axial region (14) due to a greater surface area of the outer circumferential surface (1a) being occupied by the cooling devices (3) in the first axial region (13) than in the second axial region (14).
